(19) United States
(12) Patent Application Publication
(10) Pub. No.: US 2002/0170861 A1
(43) Pub. Date: Nov. 21, 2002

(54) Solid product level indicator

(76) Inventors: Lee J. Monsrud, Inver Grove Heights, MN (US); Joshua L. Thielen, Inver Grove Heights, MN (US); Stephen X. Skaff, Owatonna, MN (US); Michael P. Kremer, Rosemount, MN (US)

Correspondence Address: Michael L. Mau, Mau & Krull, P.A., Suite E, 1250 Moore Lake Drive East, Fridley, MN, 55432, US

(21) Appl. No.: 09/920,154

(22) Filed: Aug. 1, 2001

Related U.S. Application Data
(63) Continuation-in-part of application No. 09/858,320, filed on May 15, 2001.

(51) Int. Cl. C02F 1/00

(52) U.S. Cl. 210/744

(57) ABSTRACT

A solid product level indicator (100) for determining the specific gravity of a use-solution (120) thereby indicating the concentration of the solid product (123) dissolved in the use-solution (120) includes a float assembly (125). The float assembly (125) includes a float (101) and a float stem (102). A guide member (104, 106 and 108) positions and guides the float (101). Magnets (114) contained inside the float (101) trigger a signal mechanism (112) inside the float stem (102) when the float (101) is displaced along the stem (102) due to the decrease in the specific gravity of the use-solution (120) when the concentration of the solid product (123) is low. The float assembly (125) can be positioned to provide early or late alert to allow replenishment of the solid product (123) before the supply of solid product (123) is critically low. The solid product level indicator (100) can be used in systems with constant liquid levels or variable liquid levels.

This application is a continuation-in-part of U.S. patent application Ser. No. 09/858,320, filed May 15, 2001.

### BACKGROUND OF THE INVENTION

1. Field of the Invention

The present invention relates to a solid product level indicator for determining the specific gravity of a use-solution thereby indicating the concentration of the solid product in the use-solution.

2. Description of the Prior Art

Water treatment systems are used for water softening, which occurs by running water through an ion exchange resin. The ion exchange resin replaces the calcium and magnesium cations in the water with sodium cations. As the ion exchange resin gives up its sodium cations and becomes loaded with calcium and magnesium cations, it eventually loses its capacity to soften water and the ion exchange resin must be replenished with sodium cations. The process by which the capacity of the ion exchange resin to soften water is restored and the sodium ions are replenished is referred to as regeneration. In regeneration, brine, which is a concentrated or saturated salt solution, is passed through the ion exchange resin and the cations in the ion exchange resin are replaced with sodium ions. In this way, the relatively expensive ion exchange resin may be used repeatedly in the softening process.

The conventional water softening system includes a brine tank, which serves as a source of a brine solution, and brine is produced by adding water and salt to the brine tank. The brine is removed from the brine tank and used to regenerate the ion exchange resin. As the salt is consumed during this process, it is necessary that salt be periodically added to the brine tank. Salt is necessary for the proper functioning of the system and adding salt is the only regular maintenance most modem systems require. Therefore, it is important to be alerted when the salt concentration is low in the brine tank.

Maintaining an adequate salt concentration in a brine tank is important to ensure consistent water softening. The commercialized methods known for determining salt concentration involve using microprocessors, which are expensive and complicated. The present invention addresses the problems in the prior art, and a float is utilized in the present invention. Floats are inexpensive and relatively simple yet effective for determining specific gravity of a solution.

### SUMMARY OF THE INVENTION

In a preferred embodiment device for determining the specific gravity of a use-solution thereby indicating the concentration of a solid product contained in a liquid creating the use-solution, the device includes a float having a predetermined specific gravity and a stem to which the float is operatively connected and along which the float may be displaced when the specific gravity of the use-solution changes. A signal mechanism provides a signal when the specific gravity of the use-solution is low thereby indicating when the concentration of the solid product in the use-solution is low.

In a preferred embodiment device for determining the specific gravity of a brine solution in a tank thereby indicating the concentration of salt contained in the brine solution, the tank has a bottom and a top. A stratification layer of the brine solution is created by a more concentrated brine solution proximate the bottom of the tank having a first specific gravity and a less concentrated brine solution proximate the top of the tank having a second specific gravity. A stem is located within the tank, and a float having a predetermined specific gravity less than said first specific gravity but greater than said second specific gravity. The float is operatively connected to the stem and is displaced along the stem relative to the stratification layer. A signal mechanism provides a signal when the stratification layer of the brine solution reaches a predetermined level thereby indicating when the concentration of the salt in the brine solution is low.

In a preferred embodiment method for determining the specific gravity of a use-solution, a float is placed in the use-solution. The float has a predetermined specific gravity and is displaceable in response to a change in the specific gravity of the use-solution. The use-solution is allowed to become less concentrated thereby having a lower specific gravity. A low concentration of the use-solution is signaled whereby the float is displaced in response to a decrease in the specific gravity of the use-solution.

In a preferred embodiment method of detecting a low salt level of a brine solution contained in a brine tank of a water treatment system, the brine solution containing salt therein and having a specific gravity, a float is placed in the brine tank. The float has a predetermined specific gravity. It is determined when the float in the brine tank is positioned at a first height such that an adequate supply of the salt is present in the brine solution. The salt is allowed to reach the low salt level within the brine solution. It is indicated when the float in the brine tank is positioned at a second height such that an inadequate supply of the salt is present in the brine solution and the specific gravity of the brine solution is less than that of the predetermined specific gravity. The second height is lower than the first height.

In a preferred embodiment device for determining the specific gravity of a use-solution thereby indicating the concentration of a solid product contained in a liquid creating the use-solution, the device includes a float having a predetermined specific gravity and a stem to which the float is operatively connected and along which the float may be displaced when the specific gravity of the use-solution changes. A signal mechanism provides a delayed signal when the specific gravity of the use-solution is low thereby indicating when the concentration of the solid product in the use-solution is low. The float has a variable position thereby allowing the delayed signal to be an early signal or a late signal.

In a preferred embodiment method of detecting a low salt level of a brine solution contained in a brine tank of a water treatment system, the brine solution containing salt therein and having a specific gravity, the brine tank having a top and a bottom, a float is placed in the brine tank. The float has a predetermined specific gravity and is positioned in a stratification layer. The stratification layer is formed by a more dense brine solution proximate the bottom of the brine tank and a less dense brine solution proximate the top of the brine tank. It is determined when the float in the brine tank is positioned at a first height such that an adequate supply of the salt is present in the brine solution. The salt is allowed to reach the low salt level within the brine solution. It is then indicated when the float in the brine tank is positioned at a second height such that an inadequate supply of the salt is present in the brine solution and the specific gravity of the brine solution is less than that of the predetermined specific gravity. The second height is lower than the first height.

In a preferred embodiment device for determining the specific gravity of a use-solution thereby indicating the concentration of a solid product contained in a liquid creating the use-solution, a float assembly has a float with a predetermined specific gravity and a stem to which the float is operatively connected and along which the float may be moved vertically when the specific gravity of the use-solution changes. A guide member has a rod, a guide, and a well tube. The rod is operatively connected to the stem, the guide is operatively connected to the rod proximate the float, and the well tube surrounds the float wherein the guide positions and guides the float vertically within the well tube. A signal mechanism provides a signal when the specific gravity of the use-solution is low thereby indicating when the concentration of the solid product in the use-solution is low wherein the rod positions the float assembly at variable heights to provide a variable alert for the signal.

### BRIEF DESCRIPTION OF THE DRAWINGS

FIG. 1 is a front elevational view of a solid product level indicator positioned at a first height inside a tank containing a solid product;

FIG. 2 is a front elevational view of the solid product level indicator shown in FIG. 1 positioned at a second height inside the tank containing the solid product;

FIG. 3 is a front view of the solid product level indicator shown in FIG. 1;

FIG. 4 is a cross-sectional view of the solid product level indicator shown in FIG. 1;

FIG. 5 is a front view of a well tube of the solid product level indicator shown in FIG. 1;

FIG. 6 is a schematic view of an electrical circuit used in the solid product level indicator shown in FIG. 1; and

FIG. 7 is a flow diagram illustrating the operation of an embodiment of the solid product level indicator shown in FIG. 1.

### DETAILED DESCRIPTION OF THE PREFERRED EMBODIMENT

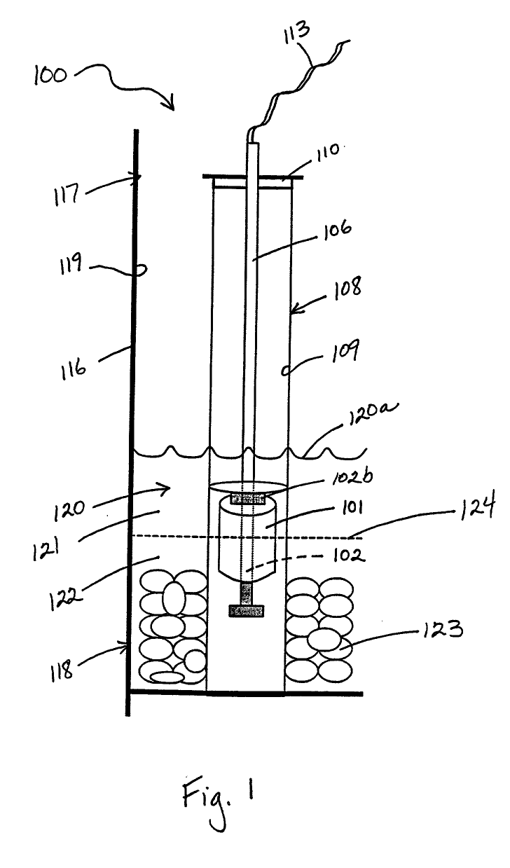

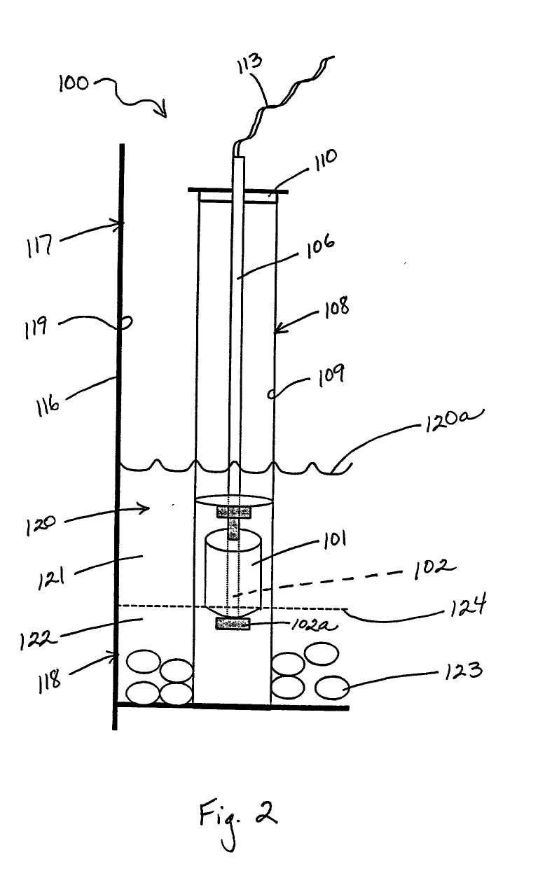

A preferred embodiment solid product level indicator constructed according to the principles of the present invention is designated by the numeral 100 in FIGS. 1 and 2.

In many applications of the present invention, it is desirable to maintain a certain concentration of a solid product dissolved in a liquid. When a solid is dissolved in a liquid, the specific gravity or density of the resulting solution typically increases. Utilizing this principle, the solid product level indicator 100 monitors the solution density and is used to alert the operator when more solid product should be added to the solution. One example is salt dissolved in water to create a brine solution for use in recharging the resin of a water softener. If the concentration of the salt in the brine solution is not high enough, the resin will not be fully regenerated and the water softener will then not operate properly. In such applications, it is important to ensure that a certain amount of salt is present to keep the brine solution concentration at a critical minimum level. The solid product level indicator 100 monitors the brine solution density and when the concentration of solution reaches a certain low level, the solid product level indicator 100 signals when more of the solid product should be added to the container.

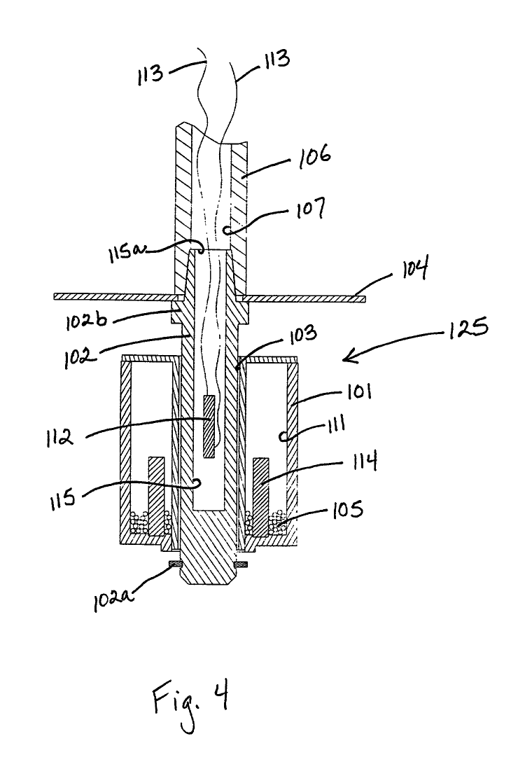

FIG. 4 shows the preferred embodiment solid product level indicator 100, which includes a float assembly 125. The float assembly 125 includes a float 101 and a float stem 102. The float 101 is a hollow, cylindrical, donut-shaped member having a bore 103 running axially through the center. The walls of the float 101 are operatively connected to form a water tight compartment and define a cavity 111 and the bore 103. The float 101 should be made of a material that resists corrosion and does not absorb water, salt, or brine, such as foamed polypropylene. The float 101 has a preferred density of approximately 1.10 grams per cubic centimeter. This particular density is half way between the density of water (1.00), and the density of a saturated salt solution (1.20). Weights 105 are placed inside the cavity 111 to give the float 101 a predetermined specific gravity, which is discussed in more detail below. It is also possible to modify the weight of the walls of the float 101 to obtain the predetermined specific gravity, but placing weights inside the cavity 111 is easier to adjust. In addition, a magnet 114 may be placed inside cavity 111 to provide activation of a signal mechanism 112 such as a reed switch when the magnets 114 are in the vicinity of the reed switch. The float stem 102 has a first stop 102a proximate the bottom and a second stop 102b proximate the top runs through the bore 103 thereby engaging the float 101. The first stop 102a and the second stop 102b are larger than the diameter of the bore 103 and the float is positioned between the stops 102a and 102b. Therefore, the float 101 travels up and down the stem 102 and the stops 102a and 102b limit the travel of the float 101 along the stem 102.

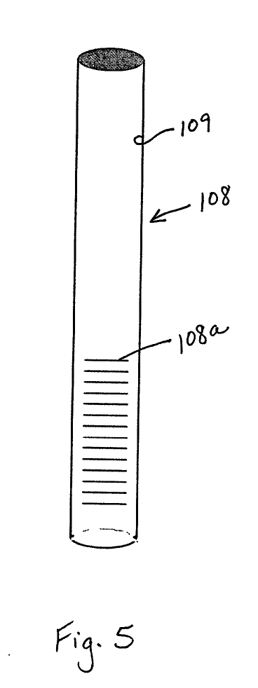

Operatively connected to the stem 102 proximate the top of the second stop 102b is a hollow rod 106 having a bore 107. The rod 106 supports the float assembly 125 and encloses the wires 113 from the signal mechanism 112 to protect the wires 113 from corrosion by the use-solution 120. At the juncture of the stem 102 and the rod 106 is the disc-shaped float guide 104. The float guide 104 keeps the float 101 and the rod 106 centered inside a well tube 108. The well tube 108 is a cylindrical tube having a cavity 109 in which the float 101 is placed. The preferred embodiment well tube 108 is made of plastic such as polyethylene, but it is recognized that any material that is resistant to corrosion in brine may be used. As shown in FIG. 5, the well tube 108 is made permeable by a plurality of slots 108a approximately ⅛ inch wide and three inches long spaced approximately one-half inch from one another. However, holes or perforations that are small relative to the size of the solid product 123 and a screen member are also acceptable to make the well tube 108 permeable. The float guide 104 has a diameter slightly less than the diameter of the cavity 109 to keep the float 101 and the rod 106 aligned within the well tube 108. The well tube 108 keeps the solid product 123 away from the float 101 to prevent interference with the float 101 travel and to prevent damage to the solid product level indicator 100 components by being in close proximity to the solid product 123. The float guide 104 ensures that the float 101 does not contact the sides of the well tube 108 thereby ensuring a more accurate reading of the float 101. A well tube cap 110 covers the well tube 108 and is operatively connected to the rod 106 to keep the rod positioned within the well tube 108. The well tube cap 110 also prevents salt 123 and debris from entering the well tube 108 in addition to securing and supporting the rod 106. When adding salt 123 to the brine tank 116, the well tube cap 110 ensures that the salt 123 is not poured over the float 101 to bury it and prevent it from being displaced to sense the correct concentration of salt 123 in the use-solution 120. Therefore, the float 101 only contacts the use-solution 120 to more accurately indicate the salt concentration. A clamp 110a secures the rod 106 proximate the cap 110, and the rod 106 can be moved up or down to change the vertical position of the float assembly 125 within the brine tank 116. Therefore, the rod 106, the float guide 104, and the well tube 108 act as a guide member for the float 101.

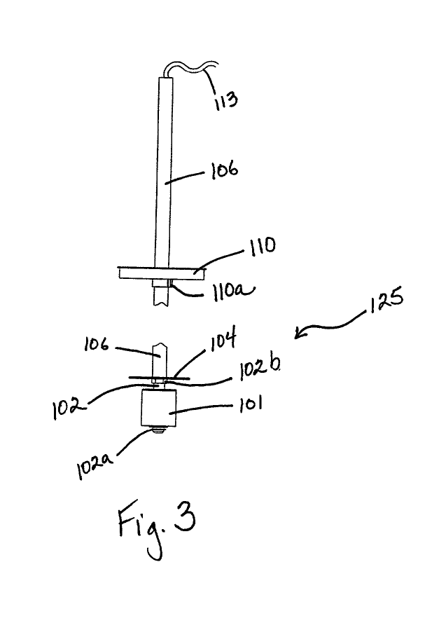

The float stem 102 also includes a cavity 115 and an opening 115a. The opening 115a is located proximate the top of the stem 102 and provides access to the cavity 115. The cavity 115 may contain a signal mechanism 112 such as a reed switch, which is triggered by the magnet 114 when the float is displaced due to a decrease in the specific gravity of the use-solution 120, and the wires 113 from the signal mechanism 112 are threaded through the opening 115a, into the bore 107, and out of the solid product level indicator 100. The signal mechanism 112 is operatively connected to the walls of the stem 102 forming the cavity 115 by means well known in the art. The wires 113 connect the reed switch inside the stem 102 to the signal device such as an indicator light (not shown). FIG. 3 shows how these components are assembled.

In the preferred embodiment shown in FIGS. 1 and 2, a brine tank 116 includes a top 117, a bottom 118, and a cavity 119, and the well tube 108 is placed inside the cavity 119 of the brine tank 116. A use-solution 120 having a top level 120a is created within the brine tank 116 by dissolving a solid product 123 such as salt in a liquid. The liquid that the solid product 123 is dissolved in could be water or another liquid such as a solvent. Because of the relatively stagnant nature of the brine tank 116, the use-solution 120 includes a less concentrated solution 121, a more concentrated solution 122, and a stratification layer 124. The stratification layer 124 is a relatively defined border between the more concentrated solution 122 more proximate the bottom 118 and the less concentrated solution 121 more proximate the top 117. Also proximate the bottom is the solid product 123 such as salt. The form of the salt could be pellets, granular, powder, or solid blocks or the salt could even be in a liquid form. FIG. 1 shows the float 101 limited by stop 102b and positioned at a first height, which indicates that an adequate concentration of the salt 123 is present in the use-solution 120 and the specific gravity of the use-solution 120 is greater than that of the predetermined specific gravity of the float 101. FIG. 2 shows the float 101 limited by stop 102a and positioned at a second height, which indicates that an inadequate concentration of the salt 123 is present in the use-solution 120 and the specific gravity of the use-solution 120 is less than that of the predetermined specific gravity of the float 101, and the signal mechanism 112 is activated to alert the operator to replenish the salt 123 supply within the brine tank 116.

The preferred embodiment solid product level indicator 100 provides a low solid product concentration alert for the solid product 123 dissolved in the use-solution 120 in a brine tank 116 used for water softening. There are several water softener models in which the height of the liquid level is always constant in the tank because the water softener fills to a float cut-off switch whether or not there is salt in the tank. The present invention responds to the density of the use-solution 120, which is directly related to the amount of salt 123 present in the brine tank 116, rather than just the height of the liquid level. If the liquid level 120a falls, the float 101 would also trigger the signal mechanism 112. Therefore, the present invention accurately reflects the level and the actual concentration of the solid product 123 dissolved in the use-solution 120, which depends on three variables. The three variables are the temperature of the use-solution 120, the time the solid product 123 is in contact with the liquid, and the type of solid product 123 used in the use-solution 120. When the temperature of the use-solution 120 in the brine tank 116 is cool, less product 123 will be dissolved in the use-solution 120. The longer the product 123 is in contact with the liquid, the more product 123 dissolves in the liquid up to the saturation point of the use-solution 120. The form of the product 123 is also a variable because small granules of salt are less compact and thus displace more water per equal weight of salt compared to pellets or solid blocks of salt. Under extreme conditions, such as cold temperatures of the use-solution 120 or the use of solid product blocks, it could take several hours for the use-solution 120 to become saturated. In most situations, it will take only a few minutes for the salt to dissolve sufficiently to raise the float 101.

For proper operation of a water softener, the resin bed needs an adequate amount of salt dissolved in the liquid to completely recharge the resin. If the brine tank 116 is fully loaded with salt to a level above the liquid level, then the use-solution 120 will generally be concentrated enough to recharge the resin. However, as the amount of solid product 123 in the brine tank 116 decreases with recurrent regenerations, the three variables discussed above become critically important. Depending on the temperature, time, and salt form, the present invention will more accurately reflect when salt needs to be added to the use-solution 120 in the brine tank 116.

In operation, the solid product level indicator 100 detects the level of solid product 123 remaining in a container such as a brine tank 116 by measuring the concentration of the solid product 123 dissolved in a liquid using specific gravity. The solid product level indicator 100 employs a float 101 to monitor the use-solution 120 density. The float 101 is buoyant in a concentrated use-solution 120 but sinks in a dilute use-solution 120 or water. When the float 101 is buoyant, as shown in FIG. 1, the reed switch is in the open position. When the float 101 sinks along the stem 102, as shown in FIG. 2, the magnets 114 create a magnetic field around the reed switch inside the stem 102 that causes the reed switch contacts to close, which allows electricity to flow and activate an alert system (not shown) thereby indicating to the operator the need to add more solid product 123 to the brine tank 116. In the preferred embodiment, the alert system includes a delay timer and an alert indicator, which can be a visual (light) and/or an audible (alarm) device. The delay timer is useful because it takes a period of time for the solid product 123 to dissolve in the liquid and the delay timer may be adjusted accordingly. For example, when fresh water is added to the brine tank 116, the solid product 123 must dissolve in the fresh water. When a sufficient amount of solid product 123 has dissolved, the specific gravity increases causing the float 101 to rise along the stem 102. Depending on the solid product 123 form and other factors, it may take from minutes to several hours for an adequate amount of salt to dissolve in water. The delay timer is also useful in a water softener application because the brine tank 116 is temporarily emptied of liquid during each regeneration. It is important that the low salt alert activation be delayed beyond the regeneration time so that a false alert is not experienced. The duration of the regeneration can vary from only 5 to 10 minutes up to several hours, depending upon the type of water softener used. Typically, a two hour delay is sufficient for most water softener types. The delay timer prevents a false alert in these two examples.

The float 101 has a predetermined density and is displaceable along the stem 102 in response to a change in specific gravity of the use-solution 120. The float 101 will rise at a higher solution density and will sink at an equivalent or lower solution density to the density of the float 101. In the preferred embodiment, the float 101 has a predetermined density of 1.10. It is recognized that the density of the float 101 could be varied depending upon the application. In a brine tank 116, the density could be more than 1.00 and less than 1.20, but the preferred range is approximately 1.05-1.15. In the preferred embodiment, the use-solution 120 is stratified due to the relatively stagnant nature of the brine tank 116. The use-solution 120 is not mixed well and there is a layer of dense use-solution 122 below a layer of dilute use-solution 121 thereby forming a stratification layer 124. The dense layer 122 is approximately 22-26% salt and has a specific gravity of approximately 1.16-1.20. The dilute layer 121 is approximately 1-7% salt and has a specific gravity of approximately 1.01-1.05. The stratification phenomenon lends itself nicely to the implementation of the solid product level indicator 100 because the density float 101 positions itself at the stratification layer 124.

It was found that the height of the stratification layer 124 was elevated when there was ample salt 123 in the tank 116. As the amount of salt 123 in the tank 116 decreases, the height of the stratification layer 124 consequently decreases. Conversely, as the amount of salt 123 in the tank 116 increases, the height of the stratification layer 124 increases. This is shown in FIGS. 1 and 2. This is an ideal situation for the density-float 101 operation. Because of the stratification phenomenon of the use-solution 120, the density float 101 is able to trigger an alert before the salt 123 is depleted. This provides an early warning system that salt 123 needs to be added soon to the brine tank 116. If the use-solution 120 were uniform throughout, the float 101 would float at the top level 120a of the use-solution 120 because there would be no stratification layer 124. The float 101 would sink when the salt concentration is low, which would give a later response compared to a stratified use-solution 120. In a uniform use-solution, such an early warning system would not be possible because by the time the density of a uniform solution falls, the salt would be nearly completely gone and there would not be enough dissolved salt to completely recharge the water softener. The early warning feature is one advantage of the density-float 101 system over other methods including, for example, a simple water-buoyant float that measures displacement.

In the preferred embodiment, the vertical position of the float assembly 125 is variable and can be adjusted by repositioning the rod 106 vertically within the brine tank 116 to achieve an early alert or a late alert, depending upon operator preference, due to the stratification phenomenon of the use-solution 120. If the float assembly 125 is placed more proximate the top 117 of the brine tank 116, an early alert will be given. If the float assembly 125 is placed more proximate the bottom 118 of the brine tank 116, a late alert will be given. The preferred position of the float assembly 125 is dependent upon the size of the brine tank 116, size of the water softener, and the brine tank 116 filling mechanism. In general, the float assembly 125 should be positioned such that it causes an alert when the amount of solid product 123 remaining is three times the amount needed to regenerate the water softener. Also, the weight or density of the float 101 could be changed to cause an early alert or a late alert. The density of the float 101 would very likely need to change when a solid product other than salt is used. The densities of solutions can vary widely depending on the type of product being dissolved, and the extent of its solubility in the liquid.

In its most basic form, the present invention is a sensor located at an adjustable position in a liquid container and an output to indicate that replenishment of a product is needed in the container. Instead of using a magnet 114 embedded in the float 101 and a reed switch, other mechanisms could be employed such as a Hall effect switch, a light beam, or a visual or mechanical indicator could be used in conjunction with the float 101. In a Hall effect switch, a transistor is utilized to close the switch contacts. The light beam could use a transmitter and a receiver blocked by the float 101. For a visual or a mechanical indicator, the float 101 could be positioned so that it can be seen or it could trip a flag to indicate the low salt condition. The float 101 could also physically push against a mechanical switch. In its simplest form, the position of the float 101 could be visually observed by the operator, in which case electrical components are not needed. Alternatively, the electrical components in the system could be grouped into one printed circuit board, or could alternatively be integrated into a microprocessor.

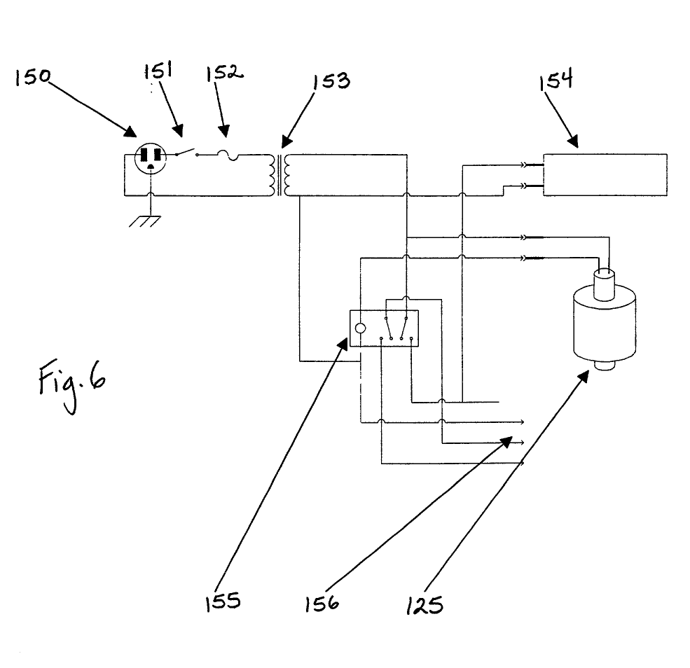

A suitable schematic of the present invention is shown in FIG. 6. It is understood that other electrical configurations could also be used to provide for operation of the invention. Briefly, the schematic shown in FIG. 6 shows a power switch 151 and fuse 152 connected between the 120 volt AC line plug 150 and the 24 volt AC power transformer 153. These components provide convenient connection of the alert system to standard AC power and over-current protection along with on/off control of the system. The transformer 153 is connected to the delay-on-make relay timer 155 such as a Crouzet Corp. type BARU110A or similar. The float assembly 125, containing the reed switch is connected to both the transformer 153 and the relay timer 155. In this configuration, the float assembly 125, containing the reed switch, controls when the relay timer 155 is activated or de-activated. The low level alert 154 is suitably connected to the transformer 153 and the alert output of the relay timer 155. Optionally, remote alert outputs 156 are provided for this invention. It is also understood that a regeneration counter may also be utilized in the electrical schematic, by means well known in the art, to count the number of times the unit has regenerated.

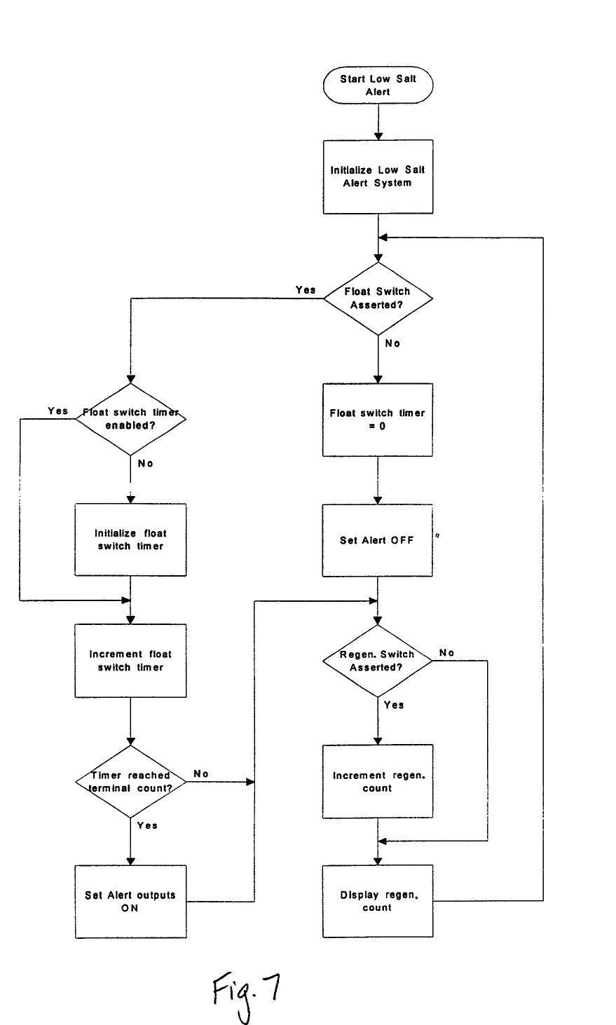

In FIG. 7, a flow diagram illustrating the operation of low salt alert used in an embodiment of the solid product level indicator 100 is shown. First, the low salt alert system is started and the low salt alert system is initialized. If the signal mechanism 112 such as a float switch is asserted, it is then determined whether the float switch timer is enabled. Once the float switch timer is initialized if it was not already enabled, the float switch timer is incremented. If the timer has reached the terminal count, the alert outputs are set to the “on” position. If the timer has not reached the terminal count or the alert outputs are on, it is then determined if the regeneration switch has been asserted. If it has been asserted, the regeneration count is incremented. If it has not been asserted or after the regeneration count has been incremented, the regeneration count is displayed. At this stage the process returns to the point where it is determined whether the float switch has been asserted.

If the signal mechanism 112 such as a float switch is not asserted, the float switch timer is set to zero and the alert is set to the “off” position. Then it must be determined whether the regeneration switch has been asserted. If it has been asserted, the regeneration count is incremented. If it has not been asserted or after the regeneration count has been incremented, the regeneration count is displayed. At this stage the process returns to the point where it is determined whether the float switch has been asserted.

In addition, the alert device could be located in a remote location other than at the brine tank 116. Optionally, the remote alert device could be wireless, using radio frequency devices, use X-10 powerline carrier transmission devices, or other available technology. In the preferred embodiment, the alert device is a low voltage blinking light such as model 9253-2464 by Ecolab Inc. The delay timer is preferentially a “delay-on-make” timer such as model BARU110A by Crouzet Corp., which is a SPDT 10A delay-on-make relay timer range 0.1 seconds to 10 hours. When the timer is energized via the float switch, the timer will delay the alert signal for a predetermined time. The particular time will depend on the water softener model and brine tank 116 size and can range from approximately no delay up to a four hour delay.

As mentioned earlier, it is understood that other electrical configurations known in the art could be used to provide for operation of the present invention. The electrical configurations would necessarily be quite different depending upon the type of water softener used. Water softeners vary widely as to how the brine tanks are filled and emptied of liquid and the sequence of steps in the regeneration process, and this necessitates different electrical components and logic. For example, one type of water softener manufactured by Ecowater Inc., model #PA070FA, utilizes a dry storage of salt in the brine tank. In this type of water softener, a different electrical configuration would be used from that presented in FIGS. 6 and 7. Since the brine tank used in this type of water softener is “dry” most of the time, a signal mechanism from the water softener would be needed to indicate when it is appropriate to begin monitoring the float for a low salt condition. In this situation, the float should only be monitored during the regeneration process when the brine tank is filled with liquid. In addition, the delay time in this situation would be relatively short or non-existent, reflecting only the time it takes for the salt to dissolve to a sufficient level. Furthermore, a latching type relay should be substituted for the relay timer 155. The relay should “latch” so that the alert condition would be maintained long enough for an operator to receive the notification. Finally, a reset mechanism should be used to release the latching relay to return the indicator to normal operating conditions. Therefore, it is understood that the present invention may be used in various types of water softeners and not just in those types herein described.

Further, the present invention could be used for any solid that is dissolved in a liquid to create a use-solution because the specific gravity of the use-solution is an indication of the concentration. This invention can be used not only as a low product alert but also as a signal of when to dose the product solution. In other words, when the solution concentration gets high enough, the sensor can cause the solution to be automatically transferred into a washing machine for example. Other possible uses include day tanks, make up tanks, and pest control.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A device for determining the specific gravity of a use-solution thereby indicating the concentration of a solid product contained in a liquid creating the use-solution, comprising:
a. a float having a predetermined specific gravity;
b. a stem to which said float is operatively connected and along which said float may be displaced when the specific gravity of the use-solution changes; and
c. a signal mechanism, said signal mechanism providing a signal when the specific gravity of the use-solution is low thereby indicating when the concentration of the solid product in the use-solution is low.

2. The device of claim 1, wherein said float has a variable vertical position.

3. The device of claim 1, wherein said signal mechanism provides a delayed signal.

4. The device of claim 1, wherein the use-solution is a brine solution in a tank having a top and a bottom and the solid product is salt.

5. The device of claim 4, further comprising a stratification layer of the brine solution created by a more concentrated brine solution proximate the bottom of the tank having a first specific gravity and a less concentrated brine solution proximate the top of the tank having a second specific gravity, wherein said predetermined specific gravity of said float is less than said first specific gravity but greater than said second specific gravity, said float being displaced along said stem relative to said stratification layer.

6. The device of claim 5, wherein said predetermined specific gravity of said float is approximately 1.05 to 1.15.

7. The device of claim 6, wherein said predetermined specific gravity of said float is approximately 1.10.

8. A device for determining the specific gravity of a brine solution in a tank thereby indicating the concentration of salt contained in the brine solution, the tank having a bottom and a top, comprising:
a. a stratification layer of the brine solution created by a more concentrated brine solution proximate the bottom of the tank having a first specific gravity and a less concentrated brine solution proximate the top of the tank having a second specific gravity;
b. a stem within the tank;
c. a float having a predetermined specific gravity less than said first specific gravity but greater than said second specific gravity, said float being operatively connected to said stem and being displaced along said stem relative to said stratification layer; and
d. a signal mechanism, said signal mechanism providing a signal when said stratification layer of the brine solution reaches a predetermined level thereby indicating when the concentration of the salt in the brine solution is low.

9. The device of claim 8, wherein said predetermined specific gravity of said float is approximately 1.05 to 1.15.

10. The device of claim 9, wherein said predetermined specific gravity of said float is approximately 1.10.

11. The device of claim 8, wherein the signal mechanism is a reed switch.

12. A method for determining the specific gravity of a use-solution, comprising:
a. placing a float in the use-solution, said float having a predetermined specific gravity and being displaceable in response to a change in the specific gravity of the use-solution;
b. allowing the use-solution to become less concentrated thereby having a lower specific gravity; and
c. signaling a low concentration of the use-solution whereby said float is displaced in response to a decrease in the specific gravity of the use-solution.

13. The method of claim 12, wherein the use-solution is a brine solution.

14. The method of claim 12, wherein a reed switch is used to signal the low concentration of the use-solution.

15. A method of detecting a low salt level of a brine solution contained in a brine tank of a water treatment system, the brine solution containing salt therein and having a specific gravity, comprising:
a. placing a float in the brine tank, said float having a predetermined specific gravity;
b. determining when said float in the brine tank is positioned at a first height such that an adequate supply of the salt is present in the brine solution;
c. allowing the salt to reach the low salt level within the brine solution; and
d. indicating when said float in the brine tank is positioned at a second height such that an inadequate supply of the salt is present in the brine solution and the specific gravity of the brine solution is less than that of the predetermined specific gravity, said second height being lower than said first height.

16. The method of claim 15, wherein said predetermined specific gravity of said float is approximately 1.05 to 1.15.

17. The method of claim 16, wherein said predetermined specific gravity of said float is approximately 1.10.

18. A device for determining the specific gravity of a use-solution thereby indicating the concentration of a solid product contained in a liquid creating the use-solution, comprising:
a. a float having a predetermined specific gravity;
b. a stem to which said float is operatively connected and along which said float may be displaced when the specific gravity of the use-solution changes; and
c. a signal mechanism, said signal mechanism providing a delayed signal when the specific gravity of the use-solution is low thereby indicating when the concentration of the solid product in the use-solution is low, said float having a variable position thereby allowing the delayed signal to be an early signal or a late signal.

19. A method of detecting a low salt level of a brine solution contained in a brine tank of a water treatment system, the brine solution containing salt therein and having a specific gravity, the brine tank having a top and a bottom, comprising:
a. placing a float in the brine tank, said float having a predetermined specific gravity, said float being positioned in a stratification layer, said stratification layer being formed by a more dense brine solution proximate the bottom of the brine tank and a less dense brine solution proximate the top of the brine tank;
b. determining when said float in the brine tank is positioned at a first height such that an adequate supply of the salt is present in the brine solution;
c. allowing the salt to reach the low salt level within the brine solution; and
d. indicating when said float in the brine tank is positioned at a second height such that an inadequate supply of the salt is present in the brine solution and the specific gravity of the brine solution is less than that of the predetermined specific gravity, said second height being lower than said first height.

20. A device for determining the specific gravity of a use-solution thereby indicating the concentration of a solid product contained in a liquid creating the use-solution, comprising:
a. a float assembly having a float with a predetermined specific gravity and a stem to which said float is operatively connected and along which said float may be moved vertically when the specific gravity of the use-solution changes;
b. a guide member having a rod, a guide, and a well tube, said rod being operatively connected to said stem, said guide being operatively connected to said rod proximate said float, and said well tube surrounding said float wherein said guide positions and guides said float vertically within said well tube; and
c. a signal mechanism, said signal mechanism providing a signal when the specific gravity of the use-solution is low thereby indicating when the concentration of the solid product in the use-solution is low wherein said rod positions said float assembly at variable heights to provide a variable alert for the signal.
